(19) United States
(12) Patent Application Publication
(10) Pub. No.: US 2010/0252787 A1
(43) Pub. Date: Oct. 7, 2010

(54) High Visible/Infrared Transmittance Glass Composition

(75) Inventor: James V. Jones, Fairview, TN (US)

Correspondence Address: Zeledyne LLC;c/o MacMillan, Sobanski & Todd LLC, One Maritime Plaza, 5th Floor, 720 Water Street, Toledo, OH, 43604-1619, US

(73) Assignee: ZELEDYNE, LLC, Allen Park, MI (US)

(21) Appl. No.: 12/417,712

(22) Filed: Apr. 3, 2009

(51) Int. Cl. F21V 9/06

(52) U.S. Cl. 252/588

(57) ABSTRACT

A flat glass panel for use in applications requiring high visible and infrared transmittance (such as a solar panel) is made using lower cost batch materials containing iron oxide impurities. Iron oxide is known as an additive for decreasing infrared/visible transmittance of glass. Removal of iron oxide impurities from batch materials is very expensive. This invention uses common batch materials having iron oxide impurities to produce a glass with high transmittance by adding a clarifier comprised of 0.05 to 0.4 weight percent of manganese dioxide (MnO₂). The optional addition of vanadium pentoxide (V₂O₅) enhances ultraviolet blocking of the glass for protecting coatings within a solar panel from ultraviolet-induced damage.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to plate glass with high infrared and visible light transmittance, and, more specifically, to a high transmittance float glass made using batch materials containing iron impurities.

A typical photovoltaic solar panel comprises a layered structure with a flat glass cover layer. The photovoltaic effect responds most strongly to incident light in the visible and infrared range. Therefore, it is very important that the glass cover layer transmit as much available visible and infrared radiation into the solar panel as possible. Producing a glass with the desired properties has required special glass compositions that employ expensive rare-earth component materials such as erbium oxide, cerium oxide, or titanium oxide, making high transmittance clear glass a more expensive product than other types of glass. It would be desirable to reduce the processing and materials cost for producing flat glass panels for use as a cover layer for solar cells and for other applications requiring high visible/infrared transmittance.

Solar panels use various coatings such as anti-reflective coatings and electrical connection layers that can be damaged by excessive exposure to ultraviolet radiation. Thus, it would be desirable to reduce ultraviolet transmittance while maximizing visible/infrared transmittance.

Flat soda-lime-silica glass (as commonly used in the automotive and architectural industries) is mass produced using the well known float glass process. The basic composition of a typical batch for producing this glass is shown in Table 1, wherein the amounts of the components in the batch are based on the weight percentage to the total glass composition.

TABLE 1

| Base Glass Component | Weight % |
|---|---|
| SiO₂ | 68 to 75 |
| Al₂O₃ | 0 to 5 |
| CaO | 5 to 15 |
| MgO | 0 to 10 |
| Na₂O | 10 to 18 |
| K₂O | 0 to 5 |

The typical batch materials for obtaining the components listed in Table 1 are sand, soda ash, limestone, dolomite, and salt cake (or other sulfate-containing material). The soda ash and sulfate-containing materials are usually very low in iron oxide contamination. However, the sand, limestone, and dolomite batch materials contain significant concentrations of iron oxide unless they are chemically treated to remove it. Removing the iron oxide significantly increases the cost of the batch material. Since most glass making operations find the presence of iron oxide desirable or at least tolerable, many suppliers of batch materials have not bothered to obtain the capability of removing the iron oxide impurities. Not only are purified batch materials more expensive, but the glass manufacturer will usually have to rely on a more distant source which raises the transportation costs of the batch material. Thus, it has not been possible to utilize both inexpensive batch materials and inexpensive float glass production methods to manufacture low cost glass plates for high visible/infrared transmittance applications such as solar cells.

### SUMMARY OF THE INVENTION

The present invention uses batch materials contaminated with iron oxide. The iron oxide in the finished glass is shifted toward the oxidizing state by adding manganese dioxide to the batch to lower the amount of reduced iron left in the glass. Vanadium pentoxide may also be added to lower the ultraviolet transmittance while maintaining a high visible/infrared transmittance and high total solar energy transmittance.

In one aspect of the invention, a composition for a clear flat glass comprises a base including 60 to 75 wt % SiO₂, 0 to 5 wt % Al₂O₃, 5 to 15 wt % CaO, 0 to 10 wt % MgO, 10 to 18 wt % Na₂O, and 0 to 5 wt % K₂O. The base further includes impurities of iron oxide such that Fe₂O₃ is present at at least 0.02 wt %. A clarifier is added to the base to lower the iron redox ratio and increase the infrared transmittance of the finished glass, wherein the clarifier comprises 0.05 to 0.4 wt % MnO₂.

### BRIEF DESCRIPTION OF THE DRAWINGS

FIG. 1 is a side view of a typical solar panel construction.

FIG. 2 is a diagram showing the effect of iron oxide impurities on infrared transmittance.

FIG. 3 is a diagram showing the use of manganese dioxide to shift the state of the iron oxide to its oxidized state (i.e., to lower the iron redox ratio).

### DETAILED DESCRIPTION OF PREFERRED EMBODIMENTS

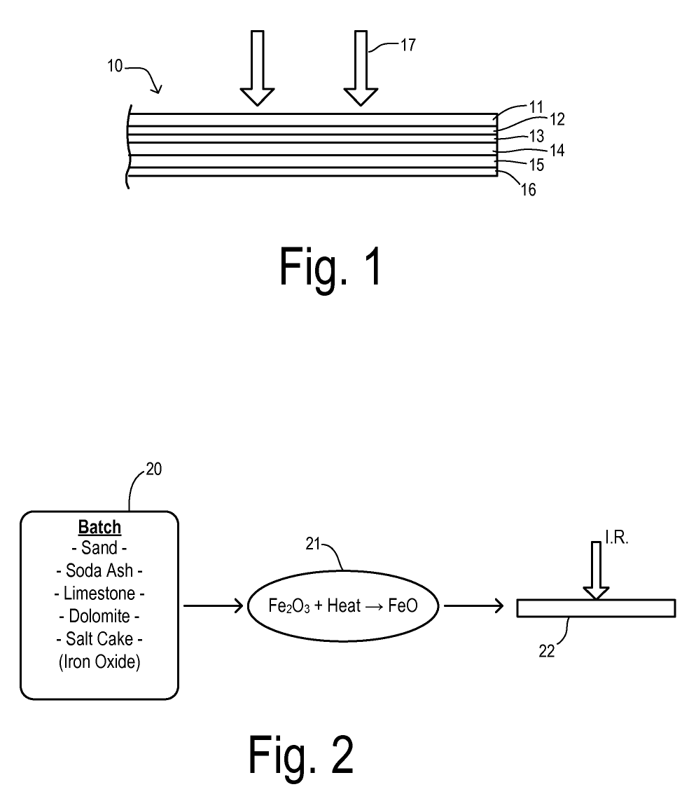

Referring now to FIG. 1, a typical solar cell construction 10 includes a glass cover layer 11 on top of an anti-reflective coating 12. A contact grid layer 13 overlies an N-type semiconductor layer 14 which has a junction with a P-type semiconductor layer 15. A contact layer 16 is provided on the bottom side of semi-conductor layer 15. Incident light 17 illuminates solar cell 10 to pass through glass cover layer 11 and anti-reflective coating 12 to generate a voltage across the semi-conductor layers. To maximize the voltage generated, glass cover layer 11 should have minimal blocking of infrared and visible radiation. To avoid deleterious effects on anti-reflective coating 12, it is desirable for glass cover layer 11 to block ultraviolet radiation.

As already mentioned, commonly available, inexpensive batch materials for making the glass cover layer contain iron oxide impurities. The effect of iron oxide on the transmittance of glass is summarized in Table 2 below.

TABLE 2

| | Example 1 | Example 2 | Example 3 |
|---|---|---|---|
| Total Fe as Wt. % Fe₂O₃ | 0.100 | 0.045 | 0.038 |
| Wt. % FeO | 0.022 | 0.008 | 0.007 |
| % LTA | 89.89 | 90.61 | 91.08 |
| % LTC | 90.14 | 90.51 | 91.17 |
| % Ultraviolet | 78.64 | 82.87 | 83.73 |
| % Infrared | 79.30 | 86.97 | 87.31 |
| % Total Solar Energy | 84.07 | 88.47 | 88.88 |

The % LTA, % LTC, % ultraviolet, % infrared, and % total solar energy in Table 2 are measured at a control thickness of 4.0 mm. Example 1 is a clear glass often used for windows, patio doors, store fronts, etc. Note that the higher iron concentration leads to lower transmittance levels. By using more expensive batch materials with substantially reduced iron impurities, transmittance levels needed for use in solar panels may be obtained as shown in Examples 2 and 3, where the total iron oxide and the reduced iron oxide are less than half the amounts of Example 1.

The use of common, low cost batch materials is shown in FIG. 2. Normally, a portion of the iron oxide in the batch becomes reduced during melting. Thus, batch 20 includes the normal components of sand, soda ash, limestone, dolomite, and salt cake, several of which can introduce impurities of iron oxide. During melting of the batch as shown at 21, heat is added to the oxidized iron which converts some of it to the reduced form of iron oxide, FeO. Due to the presence of FeO in the finished glass panel 22, infrared radiation incident on panel 22 is significantly blocked or absorbed.

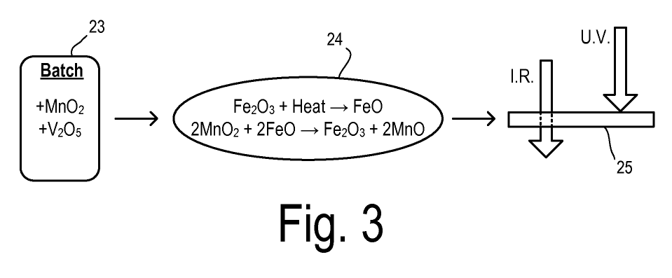

An improvement in the infrared and visible clarity of the glass according to the present invention, is shown in FIG. 3. In a batch 23 including the same common ingredients with their iron oxide impurities, a clarifier is added to shift the reduced iron oxide present in the glass melt back toward its oxidized form. Rather than using any expensive rare earth element, the clarifier added to batch 23 is comprised of manganese dioxide. Along with the clarifier, an additive such as vanadium pentoxide is optionally included to increase the ultraviolet absorption of the finished glass. As shown at step 24, reduced iron produced during heating combines with the manganese dioxide as follows:

2 MnO₂+2 FeO→Fe₂O₃+2 MnO

A finished glass panel 25 has a lowered iron redox ratio with very little reduced iron oxide remaining in glass panel 25 so that visible and infrared radiation transmittance is very high. Besides avoiding the reduced infrared and visible transmittance otherwise caused by the reduced iron oxide, the oxidized form of iron in the resulting glass has the desirable effect of lowering ultraviolet transmittance (simultaneously with the increase in infrared and visible transmittance and total solar energy transmittance). Ultraviolet transmittance is even further reduced by the optional use of vanadium pentoxide.

Table 3 provides examples of glass compositions using a base mixture with iron oxide impurities and various amounts of manganese dioxide for lowering the iron redox ratio of the finished glass. The glass samples for Table 3 were made by the following method. The batch materials were weighed out, put into a glass jar, and mixed for ten minutes to homogenize the batch materials. The batch mixture was placed into a platinum/rhodium crucible and water added at 4% of the batch weight. The water was mechanically mixed into the batch with a spatula. The crucible was placed into a furnace and held a constant temperature of 2600° F. for about two hours. The crucible was then fritted by the following process. Upon removal from the furnace, the crucible was rotated slowly to permit the molten glass to wet the inside of the crucible and then plunged into a pail of cold water. The thermal shock broke the glass into small fragments. The crucible was removed from the pail and the water was allowed to drain off. The glass particles were then mechanically mixed in the crucible and the crucible was placed back into the furnace. Two hours later, the fritting process was repeated and the crucible placed back into the furnace. About three hours later, the crucible was removed from the furnace and the molten glass was poured into a graphite mold. Once the glass cooled, the glass sample was removed from the graphite mold and placed into an annealing oven. The glass sample then annealed overnight by raising the temperature quickly to 1050° F. and then allowing the glass to cool slowly as the furnace was shut off.

TABLE 3

| | Example 4 | Example 5 | Example 6 | Example 7 |
|---|---|---|---|---|
| Total Fe as Wt. % Fe₂O₃ | 0.038 | 0.038 | 0.038 | 0.038 |
| Wt. % FeO | 0.006 | 0.005 | 0.003 | 0.000 |
| Wt. % MnO₂ | 0.05 | 0.10 | 0.20 | 0.40 |
| % LTA | 90.90 | 91.25 | 90.17 | 90.47 |
| % LTC | 90.93 | 91.28 | 90.22 | 90.34 |
| % Ultraviolet | 82.80 | 83.32 | 81.76 | 81.76 |
| % Infrared | 88.06 | 88.92 | 89.20 | 91.76 |
| % Total Solar Energy | 89.12 | 89.74 | 89.29 | 90.72 |
| Dominant Wavelength | 560.6 | 562.2 | 567.7 | 575.6 |
| % Excitation Purity | 0.3 | 0.4 | 0.6 | 1.1 |

As seen in Table 3, as the weight percent of FeO decreases, the infrared and total solar energy transmittances increase. Significant ultraviolet blocking is also maintained for all the examples, with the most ultraviolet blocking occurring for the samples with the least reduced iron (i.e., the most oxidized iron).

Vanadium pentoxide can be added to further reduce the transmittance for ultraviolet since the ultraviolet can degrade coatings applied to solar panels. Vanadium pentoxide is used because it maintains a high visible transmittance even while lowering ultraviolet transmittance. Table 4 shows various examples with vanadium pentoxide added to the same batch materials as employed for Table 3.

TABLE 4

| | | | Example | Example |
|---|---|---|---|---|
| | Example 8 | Example 9 | 10 | 11 |
| Total Fe as Wt. % Fe₂O₃ | 0.038 | 0.038 | 0.038 | 0.038 |
| Wt. % V₂O₅ | 0.012 | 0.025 | 0.050 | 0.20 |
| % LTA | 90.92 | 90.19 | 90.24 | 89.14 |
| % LTC | 91.03 | 90.30 | 90.40 | 89.43 |
| % Ultraviolet | 78.87 | 71.57 | 61.71 | 36.00 |
| % Infrared | 88.21 | 88.75 | 87.90 | 84.55 |
| % Total Solar Energy | 88.60 | 88.92 | 88.15 | 85.11 |
| Dominant Wavelength | 540.3 | 550.3 | 548.6 | 552.9 |
| % Excitation Purity | 0.3 | 0.4 | 0.8 | 1.4 |

In the foregoing examples, the presence of manganese dioxide lowers the iron redox ratio and ensures that the wt % of FeO in the finished glass is less than 0.02 weight percent. Consequently, a high visible/infrared transmittance glass is made using low cost batch materials with iron oxide impurities that would otherwise lower the visible/infrared transmittance, while avoiding high cost rare earth elements as additives.

What is claimed is:

1. A composition for a clear flat glass comprising:
a base comprising:
60 to 75 wt % SiO₂;
0 to 5 wt % Al₂O₃;
5 to 15 wt % CaO;
0 to 10 wt % MgO;
10 to 18 wt % Na₂O; and
0 to 5 wt % K₂O;
wherein the base further includes impurities of iron oxide such that Fe₂O₃ is present at at least 0.02 wt %; and
a clarifier added to the base to lower the iron redox ratio and increase the infrared transmittance of the finished glass, wherein the clarifier comprises 0.05 to 0.4 wt % MnO₂.

2. The composition of claim 1 wherein the wt % of FeO in the finished glass is less than 0.02 wt %.

3. The composition of claim 1 further comprising 0.05 to 0.3 wt % V₂O₅ added to the base to lower the ultraviolet transmittance of the glass.
